(19) United States
(12) Patent Application Publication
(10) Pub. No.: US 2008/0075981 A1
(43) Pub. Date: Mar. 27, 2008

(54) Magnetic recording medium

(75) Inventors: Kazutaka Matsuo, Osaka (JP); Mikio Kishimoto, Osaka (JP); Yuji Sasaki, Osaka (JP)

Correspondence Address: BIRCH STEWART KOLASCH & BIRCH, PO BOX 747, FALLS CHURCH, VA, 22040-0747, US

(73) Assignee: Hitachi Maxell, Ltd., Ibaraki-shi (JP)

(21) Appl. No.: 11/898,183

(22) Filed: Sep. 10, 2007

(30) Foreign Application Priority Data
Sep. 27, 2006 (JP) P2006-262350

(51) Int. Cl. G11B 5/706

(52) U.S. Cl. 428/842.9

(57) ABSTRACT

A magnetic recording medium having a nonmagnetic support and a magnetic layer formed on at least one surface of the support and containing a magnetic powder and a binder in which the magnetic powder includes at least iron and nitrogen as constituent elements, contains a Fe₁₆N₂ phase and has a spherical or ellipsoidal particle shape and an average particle size of 5 to 50 nm, and the magnetic layer contains 0.01 to 20% by weight of a silicon-containing compound based on the weight of the magnetic powder.

### FIELD OF THE INVENTION

The present invention relates to a magnetic recording medium suitable for high density recording, in particular, a magnetic tape such as a digital video tape, a backup tape for a computer, etc.

### BACKGROUND ART

Coating type magnetic recording media comprising a nonmagnetic support and a magnetic layer, which is formed on the support by coating and comprises magnetic powder and a binder, are required to have a further increased recording density with the shift of a writing-reading system from an analog system to a digital one. In particular, such requirement has been increased year by year in the video tapes and the backup tapes for computers which are used for high density recording.

To cope with short wave length recording which is inevitable to increase a recording density, it is necessary to decrease a thickness loss during recording. To this end, it is effective to decrease the thickness of a magnetic layer to 300 nm or less, in particular, to 100 nm or less. In general, a magnetoresistance head (MR head) is used as a reproducing head for reading data or signals recorded on such high density recording media, since it achieves a higher output than a conventional magnetic induction type magnetic head (MIG head).

The particle size of magnetic powder used in magnetic recording media has been decreased year by year to reduce a noise. Nowadays, acicular metal magnetic powder having a particle size of about 100 nm is practically used. Furthermore, to prevent the decrease of output caused by demagnetization during short wavelength recording, the coercive force of the magnetic powder has been increased, and a coercive force of about 238.9 A/m (about 3,000 Oe) is realized with an iron-cobalt alloy (see JP-A-3-49026, JP-A-10-83906 and JP-A-10-34085).

However, a coercive force depends on the shape of acicular magnetic particles in a magnetic recording medium comprising acicular magnetic particles. Thus, it is difficult to further decrease the particle size of such acicular magnetic particles. That is, if the particle size is further decreased, a specific surface area greatly increases and saturation magnetization greatly decreases. Consequently, the high saturation magnetization, which is the most significant characteristic of metal or metal alloy magnetic powder, is deteriorated.

In view of the above circumstance, JP-A-2001-181754 discloses a magnetic recording medium using, as a magnetic powder which is totally different from the acicular magnetic powder, a rare earth element-transition metal particulate magnetic powder such as a spherical or ellipsoidal rare earth element-iron-boron magnetic powder. This medium can greatly decrease the particle size of the magnetic powder and achieve a high saturation magnetization and a high coercive force. Therefore, this medium significantly contributes to the increase of a recording density.

Also, JP-A-2000-277311 discloses a magnetic recording medium using, as an iron magnetic powder having a non-acicular particle shape, an iron nitride magnetic powder which comprises random shape particles and a Fe₁₆N₂ phase as a main phase, and has a BET specific surface area of about 10 m²/g.

JP-A-2004-273094 discloses spherical or ellipsoidal magnetic powder containing a Fe₁₆N₂ phase and having a particle size of 5 to 50 nm as a magnetic powder suitable for use in a magnetic recording medium for high density recording. Such a magnetic powder is characterized in that it has excellent short wavelength recording characteristics which cannot be attained by conventional magnetic powders, and it contains a rare earth element, aluminum, silicon, etc. in the magnetic particles. When the magnetic powder of JP-A-2004-273094 is used in a video tape for high density recording, a backup tape for a computer, etc., it is required to have high reliability in addition to the short wavelength recording characteristics. In particular, the reliability in the case of storing the magnetic recording media at a high temperature and a high humidity is important. When magnetic powder contains a metal, a metal alloy or a metal compound, the deterioration of the recording media at a high temperature and a high humidity is unavoidable.

### SUMMARY OF THE INVENTION

An object of the present invention is to provide a magnetic recording medium which uses magnetic powder with a spherical or ellipsoidal particle shape that comprises at least iron and nitrogen as constituent elements, contains a Fe₁₆N₂ phase and has an average particle size of 5 to 50 nm and which has not only good short wavelength recording characteristics, but also excellent chemical stability and high durability.

The present invention provides a magnetic recording medium comprising a nonmagnetic support and a magnetic layer formed on at least one surface of the support and containing a magnetic powder and a binder wherein the magnetic powder comprises at least iron and nitrogen as constituent elements, contains a Fe₁₆N₂ phase and has a spherical or ellipsoidal particle shape and an average particle size of 5 to 50 nm, and the magnetic layer contains 0.01 to 20% by weight, based on the weight of the magnetic powder, of a silicon-containing compound, preferably a compound having a siloxane (Si—O) linkage.

In one preferred embodiment, the magnetic recording medium of the present invention has a coercive force of 79.6 to 318.4 kA/m (1,000 to 4,000 Oe), a squareness ratio (Br/Bm) of 0.6 to 0.9 in the longitudinal direction, and a product (Bm·t) of a saturated magnetic flux density (Bm) and a thickness (t) of a magnetic layer of 0.001 to 0.1 μTm.

In another preferred embodiment, the magnetic recording medium of the present invention has at least one primer layer comprising a nonmagnetic powder and a binder between the nonmagnetic layer and the magnetic layer, and a thickness of the magnetic layer of 300 nm or less, in particular, 10 to 300 nm.

Since the iron nitride magnetic powder used according to the present invention comprises at least a Fe₁₆N₂ phase and has a spherical or ellipsoidal particle shape and an average particle size of 5 to 50 nm, and further the magnetic layer contains a silicon-containing compound, the magnetic recording medium of the present invention has not only good short wavelength recording characteristics, but also excellent chemical stability and high durability.

### DETAILED DESCRIPTION OF THE INVENTION

In the magnetic powder used according to the present invention, the content of nitrogen is, based on the iron amount, from 1.0 to 20.0 atomic %, preferably from 5.0 to 18.0 atomic %, more preferably from 8.0 to 15.0 atomic %. When the content of nitrogen is too small, the smaller amount of the Fe₁₆N₂ phase is formed so that the coercive force is not effectively increased. When the content of nitrogen is too large, nonmagnetic nitrides tend to be formed so that the coercive force is not effectively increased, and the saturation magnetization is excessively decreased.

The content of the rare earth element is usually from 0.05 to 20.0 atomic %, preferably from 0.1 to 15.0 atomic %, more preferably from 0.5 to 10.0 atomic %, based on the amount of iron element. When the content of the rare earth element is too low, the dispersibility of the magnetic particles may not be sufficiently improved, and the effect to maintain the shape of the magnetic particles in a reducing step decreases. When the content of the rare earth element is too large, the ratio of the unreacted rare earth element to the rare earth element added increases, and the unreacted rare earth element interferes with the dispersing and coating steps. Furthermore, the coercive force and saturation magnetization may excessively decrease.

Examples of the rare earth element include yttrium, ytterbium, cesium, praseodymium, samarium, lanthanum, europium, neodymium, etc. Among them, yttrium, samarium or neodymium is preferably used, since these elements have a large effect to maintain the shape of the magnetic particles in the reducing step.

Apart from the rare earth element, the addition of boron, silicon, aluminum and/or phosphorus can impart a shape-maintenance effect to the magnetic particles and also improve the dispersibility of the magnetic particles. Since boron, silicon, aluminum and phosphorus are less expensive than the rare earth element, they are advantageous from the viewpoint of costs. Thus, these elements are preferably used in combination with a rare earth element.

The content of the silicon-containing compound is usually from 0.1 to 20% by weight, preferably from 0.2 to 15% by weight, more preferably from 0.3 to 10% by weight, based on the weight of the magnetic powder in the magnetic layer. When the content of the silicon-containing compound is less than 0.1% by weight, the chemical stability of the magnetic medium may not be satisfactorily improved. When it exceeds 20% by weight, a coating composition of the magnetic layer may have a very high viscosity so that a coating property of the composition tends to deteriorate.

As a silicon-containing compound, an organic silicon-containing compound, in particular, a cyclic compound is preferable. Specific examples of the organic silicon-containing compound include
cyclotrisiloxane, disiloxane, trisiloxane, 1,1,3,3-tetramethylsiloxane, pentamethyldisiloxane, 1,3-bis(dichloromethyl)-1,1,3,3-tetramethyldisiloxane, 1,3-bis(chloromethyl)-1,1,3,3-tetramethyldisiloxane, hexamethyldisiloxane, 1,3-dimethoxytetramethyldisiloxane, 1,3-diethynyl-1,1,3,3-tetramethyldisiloxane, 1,3-divinyl-1,1,3,3-tetramethyldisiloxane, 1,3-diethoxytetramethyldisiloxane, 1,3-bis(acetoxymethyl)tetramethyldisiloxane, 1,3-bis(3-chloropropyl)tetramethyldisiloxane, 1,3-bis(3-mercaptopropyl)tetramethyldisiloxane, 1,3-bis(3-hydroxypropyl)-1,1,3,3-tetramethyldisiloxane, 1,3-bis(3-aminopropyl)tetramethyldisiloxane, 1,3-bis(2-aminoethylaminomethyl)-1,1,3,3-tetramethyl-disiloxane, pentamethylpiperidinomethyldisiloxane, 1,3-dichlorotetraisopropyldisiloxane, 3-methylpiperidinomethylpentamethyldisiloxane, hexaethyldisiloxane, 1,3-dibutyl-1,1,3,3-tetramethyldisiloxane, 1-(4-methylpiperidinomethyl)-1,1,3,3-tetramethyl-3-vinyl-disiloxane, 1,3-bis(3-acetoxypropyl)tetramethyldisiloxane, 3-(4-methylpiperidinopropyl)pentamethyldisiloxane, 1,3-bis(3-glycydoxypropyl)-1,1,3,3-tetramethyldisiloxane, hexapropyldisiloxane, 1,1,3,3-tetraphenyl-1,3-divinyl-disiloxane, hexaphenyldisiloxane, 1,1,3,3,5,5-hexamethyl-1,5-dichlorotrisiloxane, hexamethylcyclotrisiloxane, 1,1,3,3,5,5-hexamethyltrisiloxane, 1,1,1,3,5,5,5-heptamethyl-trisiloxane, octamethyltrisiloxane, 1,3,5-trimethyl-1,3,5-trivinylcyclotrisiloxane, 3-ethoxyheptamethyltrisiloxane, 3-(3,3,3-trifluoropropyl)-1,1,1,3,5,5,5-heptamethyl-trisiloxane, 3-(3-chloropropyl)heptamethyltrisiloxane, heptamethyl-3-(3-hydroxypropyl)trisiloxane, 1,3,5-tris(3,3,3-trifluoropropyl)-1,3,5-trimethylcyclo-trisiloxane, hexaethylcyclotrisiloxane, 3-(2-aminoethylaminopropyl)heptamethyltrisiloxane, heptamethyl-3-(2-piperidinoethyl)trisiloxane, heptamethyl-3-(3-pyrrolidinopropyl)trisiloxane, heptamethyl-3-(3-morpholinopropyl)trisiloxane, heptamethyl-3-(3-piperadinopropyl)trisiloxane, heptamethyl-3-[3-(4-piperidinomethylaminopropyl)]trisiloxane, 3-[3-(4-cyclohexylcarbamoylpiperadino)propyl]heptamethyl-trisiloxane, 1,3,3,5-tetramethyl-1,1,5,5-tetraphenyl-trisiloxane, 1,1,3,5,5-pentaphenyl-1,3,5-trimethyltrisiloxane, hexaphenylcyclotrisiloxane, 1,3,5,7-tetramethylcyclo-tetrasiloxane, 1,7-dichloro-1,1,3,3,5,5,7,7-octamethyl-tetrasiloxane, octamethylcyclotetrasiloxane, 1,1,1,3,5,7,7,7-octamethyltetrasiloxane, decamethyltetrasiloxane, 1,3,5,7-tetramethyl-1,3,5,7-tetravinylcyclotetrasiloxane, 1,7-diacetoxyoctamethyl-tetrasiloxane, 1,3,5,7-tetraethoxy-1,3,5,7-tetramethyl-cyclotetrasiloxane, 1,3,5,7-tetrakis(3,3,3-trifluoropropyl)-1,3,5,7-tetramethylcyclotetrasiloxane, 1,3,5,7-tetramethyl-1,3,5,7-tetramethylcyclotetrasiloxane, 1,3-bis(3-trimethylsiloxypropyl)-1,1,3,3-tetramethyldisiloxane, 1,3,5,7-tetrabutoxy-1,3,5,7-tetramethylcyclotetrasiloxane, octaphenylcyclotetrasiloxane, 1,3,5,7,9-pentamethylcyclo-pentasiloxane, decamethylcyclopentasiloxane, 1,3,5,7,9-pentaethoxy-1,3,5,7,9-pentamethylcyclopentasiloxane, dodecamethylcyclohexasiloxane, hexachlorodisiloxane, 1,3-bis(bromomethyl)tetramethyldisiloxane, 1,3-bis(3-cyanopropyl)tetramethyldisiloxane, 1,3-bis(3-methacryloxypropyl)tetramethyldisiloxane, etc.

Now, the production method of the iron nitride magnetic powder used according to the present invention and a method for adding the silicon-containing compound are explained.

As a raw material for the production of the iron nitride magnetic powder, an oxide or hydroxide of iron is used. Examples of such oxide or hydroxide include hematite, magnetite, goethite, etc. The average particle size of the raw material is not limited, and is usually from 5 to 80 nm, preferably from 5 to 50 nm, more preferably from 5 to 30 nm. When the particle size of the raw material is too small, the particles tend to be sitered together in the reducing treatment. When it is too large, the particles may be less uniformly reduced so that the control of the particle size and/or magnetic properties of the magnetic powder is difficult.

The rare earth element may be adhered to the surface of the raw material particles. Usually, the raw material is dispersed in an aqueous solution of an alkali or an acid. Then, the salt of the rare earth element is dissolved in the solution and the hydroxide or hydrate of the rare earth element is precipitated and deposited on the raw material particles by a neutralization reaction, etc.

Furthermore, a compound of boron, silicon, aluminum or phosphorus may be dissolved in a solvent and the raw material is dipped in the solution so that such an element can be deposited on the raw material particles. To effectively carry out the deposition of such an element, an additive such as a reducing agent, a pH-buffer, a particle size-controlling agent, etc. may be mixed in the solution. Boron, silicon, aluminum or phosphorus may be deposited at the same time as, or alternately with the deposition of the rare earth element. The rare earth element and/or boron, silicon, aluminum or phosphorus may be deposited on the particles of a raw material, or they may be added to a raw material mixture for the preparation of the magnetic powder and precipitated on the surfaces of the magnetic particles in the heat-treatment step which is described below. The addition of these elements to the raw material mixture and the deposition of these elements on the magnetic particles prepared may be combined.

Then, the raw material particles are reduced by heating them in the atmosphere of a reducing gas. The kind of the reducing gas is not limited. Usually a hydrogen gas is used, but other reducing gas such as carbon monoxide may be used.

A reducing temperature is preferably from 300 to 600° C. When the reducing temperature is lower than 300° C., the reducing reaction may not sufficiently proceed. When the reducing temperature exceeds 600° C., the particles tend to be sintered.

After the thermal reduction of the particles, they are subjected to a nitriding treatment. Thereby, the magnetic powder comprising iron and nitrogen as the essential element according to the present invention is obtained. The nitriding treatment is preferably carried out with a gas containing ammonia. Apart from pure ammonia gas, a mixture of ammonia and a carrier gas (e.g. hydrogen gas, helium gas, nitrogen gas, argon gas, etc.) may be used. The nitrogen gas is preferable since it is inexpensive.

The nitriding temperature is preferably from 100 to 300° C. When the nitriding temperature is too low, the particles are not sufficiently nitrided so that the coercive force may insufficiently be increased. When the nitriding temperature is too high, the particles are excessively nitrided so that the proportion of Fe₄N and Fe₃N phases increases and thus the coercive force may rather be decreased and also the saturation magnetization tends to excessively decrease.

Preferably, the nitriding conditions are selected so that the content of the nitrogen atoms is usually from 1.0 to 20.0 atomic % based on the amount of iron in the magnetic powder obtained. When the content of the nitrogen atoms is too small, the coercive force is not effectively increased since the generated amount of the Fe₁₆N₂ phase is small. When the content of the nitrogen atoms is too large, Fe₄N and Fe₃N phases tend to form and thus the coercive force may rather be decreased and also the saturation magnetization tends to excessively decrease.

Different from the conventional acicular magnetic powders the magnetism of which is based on the shape magnetic anisotropy, the iron nitride magnetic powder of the present invention has the large crystalline magnetic anisotropy. Thus, when the particles of the magnetic powder have the substantially spherical shape, they may exhibit the large coercive force in one direction.

When the magnetic powder of the present invention comprises fine particles having an average particle size of 5 to 50 nm, it has a high coercive force and an adequate saturation magnetization, which enable the recording and erasing with a magnetic head. Therefore, it can provide excellent electromagnetic conversion properties to a coating type magnetic recording medium having a thin magnetic layer. Accordingly, the magnetic powder of the present invention has the saturation magnetization, coercive force, particle size and particle shape, all of which essentially serve for the formation of a thin magnetic layer.

As the silicon-containing compound, preferably a cyclic siloxane of the formula: [—R₂SiO—]ₙ wherein R is a hydrogen atom or an organic group such as an alkyl group having 1 to 21 carbon atoms, an aryl group having 6 to 48 carbon atoms, etc., and n is an integer of at least 2, preferably 4 to 6 is used.

The silicon-containing compound can be added to a magnetic paint of a magnetic layer by any conventional method. For example, the silicon-containing compound may be added to the magnetic paint of a magnetic layer when the magnetic powder, the binder and other optional components (e.g. an abrasive, a lubricant, etc.) of the magnetic paint are kneaded with a kneader, etc., or when they are dispersed with a san mill, etc., or when the viscosity of the magnetic paint is adjusted by a solvent.

The magnetic recording medium of the present invention may be produced by dispersing and mixing the iron nitride magnetic powder, the binder and other optional component(s) in a solvent, adding the silicon-containing compound to the mixture to obtain a magnetic paint, applying the magnetic paint on at least one surface of a nonmagnetic support and drying the applied magnetic paint to form a magnetic layer. Prior to the formation of the magnetic layer, a primer composition comprising nonmagnetic powder such as iron oxide, titanium oxide, aluminum oxide, etc. and a binder may be applied to the surface of the nonmagnetic support followed by drying to form a primer layer, and then the magnetic layer is formed on the primer layer.

The binder, the other optional components and the solvent used for the preparation of the magnetic paint may be conventional materials used in the production of conventional magnetic media.

Typically, the magnetic recording medium comprises a nonmagnetic support, a primer layer formed on one surface of the nonmagnetic support, a magnetic layer formed on the primer layer, and a backcoat layer formed on the other surface of the nonmagnetic support and comprising nonmagnetic powder and a binder. The nonmagnetic support, and also nonmagnetic powder, the binder and other components used for the formation of the primer layer and/or the backcoat layer may be conventional materials used in the production of conventional magnetic media. Furthermore, the primer layer and/or the backcoat layer may be formed by any conventional method.

The present invention will be illustrated by the following Examples, which do not limit the scope of the present invention.

### EXAMPLES

In the Examples, a magnetic layer was formed directly on the surface of a nonmagnetic support to form a so-called “single layer recording medium”. However, the present invention can be applied to a so-called “multi-layer recording medium” in which a primer layer is firstly formed on the surface of a nonmagnetic support and then a magnetic layer is formed on the primer layer.

### Example 1

### (A) Preparation of Iron Nitride Magnetic Powder

As a starting material, magnetite particles having a substantially spherical shape and an average particle size of 20 nm, the surfaces which are coated with an oxide layer of yttrium and aluminum, were used. The magnetite particles contained 1.2 atomic % of yttrium and 9.8 atomic % of aluminum, both based on the content of iron in the magnetite particles.

The magnetite particles were reduced in a hydrogen stream at 450° C. for 2 hours to obtain iron magnetic powder containing yttrium and aluminum. This powder was cooled to 150° C. over about 1 hour while flowing hydrogen gas, and then the hydrogen gas was switched to an ammonia gas, and the particles were nitrided for 30 hours while maintaining the temperature at 150° C. Thereafter, the particles were cooled from 150° C. to 90° C. while flowing the ammonia gas, and then the ammonia gas was switched to a mixed gas of oxygen and nitrogen to stabilize the particles for 2 hours.

After that, the particles were further cooled from 90° C. to 40° C. and maintained at 40° C. for about 10 hours, while flowing the mixed gas of oxygen and nitrogen, and then they were recovered in an air to obtain iron nitride magnetic powder containing yttrium and aluminum. The X-ray diffraction of this powder confirmed that the powder comprises the Fe₁₆N₂ phase as a main phase.

Furthermore, the magnetic particles were observed with a high dissolution transmission electron microscope. The particle shape was substantially spherical, and the average particle size was 18 nm. The saturation magnetization and coercive force of the magnetic powder, which were measured by applying a magnetic field of 1,270 kA/m (16 kOe), were 135.2 μm²/kg (135.2 emu/g) and 219.7 kA/m (2,760 Oe), respectively.

### (B) Production of Magnetic Paint

Using the iron nitride magnetic powder containing yttrium and aluminum prepared in Step (A), a magnetic paint was prepared by dispersing the following components for 10 hours with a planetary ball mill (manufactured by Fritsch GmbH) using zirconia beads.

Components of a Magnetic Paint

| | | |
|---|---|---|
| Iron nitride magnetic powder | 80 | pbw |
| Vinyl chloride-hydroxypropyl acrylate copolymer | 10 | pbw |
| (—SO₃Na group content: 0.7 × 10⁻⁴ eq./g) | | |
| Polyesterpolyurethane resin | 6 | pbw |
| (—SO₃Na group content: 1 × 10⁻⁴ eq./g) | | |
| Methyl ethyl ketone | 133 | pbw |
| Toluene | 100 | pbw |

*pbw = parts by weight

To the magnetic paint prepared above, 5.5 parts by weight of a silicon-containing compound, 1,3,5,7-tetramethylcyclotetra-siloxane (LS-8600 (trade name) manufactured by Shin-Etsu Chemical Co., Ltd.) was added and dispersed for 2 hours. After that, 4 parts by weight of a polyisocyanate (COLONATE L manufactured by Nippon Polyurethane Industry Co., Ltd.) and further dispersed for 15 minutes to obtain a final magnetic paint.

Then, the magnetic paint was coated on one surface of a polyethylene terephthalate (PET) film having a thickness of 20 μm as a nonmagnetic support while applying a magnetic field of 318.4 ka/m (4,000 Oe) so that a dry thickness of a magnetic layer was about 2 μm to form a magnetic layer on the PET film. Thereby, a magnetic recording medium of this Example was produced.

### Example 2

A magnetic recording medium was produced in the same manner as in Example 1 except that the amount of the silicon-containing compound was changed from 5.5 parts by weight to 2.8 parts by weight.

### Example 3

A magnetic recording medium was produced in the same manner as in Example 1 except that as a silicon-containing compound, octamethylcyclotetrasiloxane (LS-8620 (trade name) manufactured by Shin-Etsu Chemical Co., Ltd.) was used in place of 1,3,5,7-tetramethylcyclotetrasiloxane (LS-8600).

### Example 4

A magnetic recording medium was produced in the same manner as in Example 1 except that the amount of the silicon-containing compound was changed from 5.5 parts by weight to 0.1 parts by weight.

### Example 5

A magnetic recording medium was produced in the same manner as in Example 1 except that the amount of the silicon-containing compound was changed from 5.5 parts by weight to 0.7 parts by weight.

### Example 6

A magnetic recording medium was produced in the same manner as in Example 1 except that the amount of the silicon-containing compound was changed from 5.5 parts by weight to 10 parts by weight.

### Example 7

A magnetic recording medium was produced in the same manner as in Example 1 except that the amount of the silicon-containing compound was changed from 5.5 parts by weight to 15 parts by weight.

### Example 8

A magnetic recording medium was produced in the same manner as in Example 1 except that the amount of the silicon-containing compound was changed from 5.5 parts by weight to 20 parts by weight.

### Comparative Example 1

A magnetic recording medium was produced in the same manner as in Example 1 except that no silicon-containing compound was used.

Evaluation of Properties

From each of the magnetic recording media produced in Examples 1 to 8 and Comparative Example 1, a square piece (ca. 1 cm×ca. 1 cm) was cut out and used as a sample. Then, a coercive force in the machine direction, a squareness ratio and a saturation magnetic flux density of the sample were measured as the magnetic properties of the magnetic layer using a sample vibration type flux meter at a maximum magnetic filed of 1.273 MA/m (16 kOe). During the measurement, a hysteresis loop was recorded, and SFD (switching field distribution) is calculated from the hysteresis loop.

The chemical stability of the sample was evaluated by storing the sample at 60° C. and 90% RH for seven days, and then measuring a coercive force in the machine direction, a squareness ratio and a saturation magnetic flux density of the sample.

The results are shown in Table 1, in which the coercive forces, squareness ratios and SDF values are absolute values, and the saturation magnetic flux densities are expressed as relative values with those before storing the samples under the above conditions being “100”.

TABLE 1

| | | | | | | | | | Saturation | |
|---|---|---|---|---|---|---|---|---|---|---|
| | | | Coercive force | | Squareness | | | | magnetic flux | |
| | Si-containing compound | | (kA/m) | | ratio | | SFD | | density | |
| Example | | Amount | Origi- | After | Origi- | After | Origi- | After | Origi- | After |
| No. | Compound | (pbw) | nal | storage | nal | storage | nal | storage | nal | storage |
| 1 | 1,3,5,7-Tetramethyl- | 5.5 | 277.8 | 276.2 | 0.84 | 0.84 | 0.73 | 0.73 | 100 | 97.6 |
| | cyclotetrasiloxane | | | | | | | | | |
| 2 | 1,3,5,7-Tetramethyl- | 2.8 | 278.6 | 275.4 | 0.83 | 0.83 | 0.75 | 0.75 | 100 | 97.0 |
| | cyclotetrasiloxane | | | | | | | | | |
| 3 | Octamethylcyclotetra- | 5.5 | 274.6 | 270.6 | 0.82 | 0.82 | 0.76 | 0.77 | 100 | 93.8 |
| | siloxane | | | | | | | | | |
| 4 | 1,3,5,7-Tetramethyl- | 0.1 | 278.8 | 274.0 | 0.81 | 0.81 | 0.76 | 0.77 | 100 | 94.0 |
| | cyclotetrasiloxane | | | | | | | | | |
| 5 | 1,3,5,7-Tetramethyl- | 0.7 | 287.7 | 275.0 | 0.82 | 0.82 | 0.76 | 0.76 | 100 | 95.0 |
| | cyclotetrasiloxane | | | | | | | | | |
| 6 | 1,3,5,7-Tetramethyl- | 10 | 263.0 | 262.0 | 0.84 | 0.84 | 0.72 | 0.72 | 100 | 98.2 |
| | cyclotetrasiloxane | | | | | | | | | |
| 7 | 1,3,5,7-Tetramethyl- | 15 | 258.4 | 257.8 | 0.84 | 0.84 | 0.71 | 0.71 | 100 | 98.4 |
| | cyclotetrasiloxane | | | | | | | | | |
| 8 | 1,3,5,7-Tetramethyl- | 20 | 255.6 | 255.0 | 0.84 | 0.84 | 0.71 | 0.71 | 100 | 98.5 |
| | cyclotetrasiloxane | | | | | | | | | |

| | | | | | | | | | |
|---|---|---|---|---|---|---|---|---|---|
| Comp. 1 | None | 278.6 | 245.2 | 0.84 | 0.76 | 0.80 | 0.84 | 100 | 88.5 |

As can be seen from the results in Table 1, the magnetic recording media containing a silicon-containing compound in the magnetic layers according to the present invention (Examples 1-8) hardly suffered from the changes of the magnetic properties after being stored at 60° C. and 90% RH for seven days. That is, they had good chemical stability.

In contrast, the magnetic recording medium of Comparative Example 1 containing no silicon-containing compound in the magnetic layer suffered from the significant decrease of the saturation magnetic flux density after being stored at 60° C. and 90% RH for seven days.

What is claimed is:

1. A magnetic recording medium comprising a nonmagnetic support and a magnetic layer formed on at least one surface of the support and containing a magnetic powder and a binder wherein the magnetic powder comprises at least iron and nitrogen as constituent elements, contains a Fe₁₆N₂ phase and has a spherical or ellipsoidal particle shape and an average particle size of 5 to 50 nm, and the magnetic layer contains 0.01 to 20% by weight of a silicon-containing compound based on the weight of the magnetic powder.

2. The magnetic recording medium according to claim 1, wherein said magnetic powder contains at least one element selected from rare earth elements, boron, silicon, aluminum and phosphorus in an amount of 0.05 to 20.0 atomic % based on the amount of iron in the magnetic powder.

3. The magnetic recording medium according to claim 1, wherein said silicon-containing compound is an organic compound.

4. The magnetic recording medium according to claim 1, wherein said silicon-containing compound is a compound having a siloxane linkage.

5. The magnetic recording medium according to claim 1, wherein said silicon-containing compound is a cyclic silicon-containing compound.

6. The magnetic recording medium according to claim 1, which has a coercive force of 79.6 to 318.4 kA/m (1,000 to 4,000 Oe), and a squareness ratio (Br/Bm) of 0.6 to 0.9 in the longitudinal direction.
